(19) United States
(12) Patent Application Publication
(10) Pub. No.: US 2010/0051664 A1
(43) Pub. Date: Mar. 4, 2010

(54) REAR VIEW MIRROR CADDY

(76) Inventor: MARLIES PARA, Othello, WA (US)

Correspondence Address: FLOYD E. IVEY;IVEY Law Offices, P.S. Corp., 7233 W. Deschutes Ave., Suite C, BOX #3, KENNEWICK, WA, 99336, US

(21) Appl. No.: 12/202,115

(22) Filed: Aug. 29, 2008

(51) Int. Cl. B60R 11/00

(52) U.S. Cl. 224/545

(57) ABSTRACT

A suspension device attached to a surface, such as the back side of a motor vehicle rear-view mirror, having apertures from which to hang item including blue tooth ear pieces, sunglasses and charging cables. The device is suspended from at least two suspenders which are rigid. The suspension device resists sway. A container is received at the suspension device to contain articles such as an ipod.

### FIELD OF THE INVENTION

The invention is a device used for storage of items including items capable of being suspended. More specifically the invention is a hanging storage device which hangs from or is suspended from the rear-view mirror of a vehicle.

### BACKGROUND OF THE INVENTION

Automobile operators frequently hang items from the rear view mirror. A common problem with such items is their tendency to sway and obstruct the drivers view. Another limitation is the difficulty encountered when the operator desires to hang several items at one time. Attempting to detach one from such a group creates a tangle of the several. Trying to unhook one from the several, while driving, invites the operator to take his eyes off the road resulting in an unsafe distraction.

### SUMMARY OF THE INVENTION

This invention comprises a structure which provides storage for a numbers of items such as sunglasses, glasses, earphone pieces, blue tooth devices, charging cables, and other such items. This invention allows an operator the ability to keep her eyes on the road while, by peripheral vision, lifting sunglasses from the invention structure. This invention structure is generally planar with at least one aperture. The shape of the suspension structure resists sway providing rigidity in having a swept back wing shape at the leading edge with a concave scalloped trailing edge. The suspension structure, when used in an automotive vehicle and in association with a rear-view mirror is attached to the rear-view mirror by thin rigid leads or suspenders terminating in tabs and affixed to the rear-view mirror by velcro.

### BRIEF DESCRIPTION OF THE DRAWINGS

The foregoing and other features and advantages of the present invention will become more readily appreciated as the same become better understood by reference to the following detailed description of the preferred embodiment of the invention when taken in conjunction with the accompanying drawings, wherein:

FIGS. 1, 2, 3, 4 and 8 illustrates the suspension storage device (1) showing the storage device (1000) having a leading edge (1100), a first side (1110), a second side (1112), at least one hanging aperture (1140), at least one hook aperture (1150), a trailing edge (1160) having at least one concave scallop (1170). Also seen is at least two suspenders (1200) having a suspender storage device end (1205), a suspender brace (1220) and a suspender attachment end (1230). Also illustrated is the attachment tab (1300) and attachment velcro (1310).

FIG. 5 shows Detail 5 from FIG. 4 illustrating an embodiment of the suspender (1200) having a suspender hoop (1210) at the storage device end (1205).

FIG. 5A illustrates the suspender (1200) terminating in the suspender storage device end (1205), at the storage device (1000), integral in construction with the storage device (1000).

FIGS. 6, 7, 7A and 8 illustrate the storage device (1000) with the suspender (1200) with and without the suspender hook (1210). Illustrated in FIG. 7 is the hook aperture (1150). Also shown in FIG. 6, FIG. 7 and 7A at the storage device (1000) is a leading edge structural support (1120), a hanging aperture structural support (1145) and at the trailing edge (1160) at least one scallop (1170).

FIGS. 9, 9A, 9B, 9C and 9D illustrate a storage container (1400) having a container top (1410), a container bottom (1415), at least one container wall (1420), a container exterior (1425) and a container clip (1430).

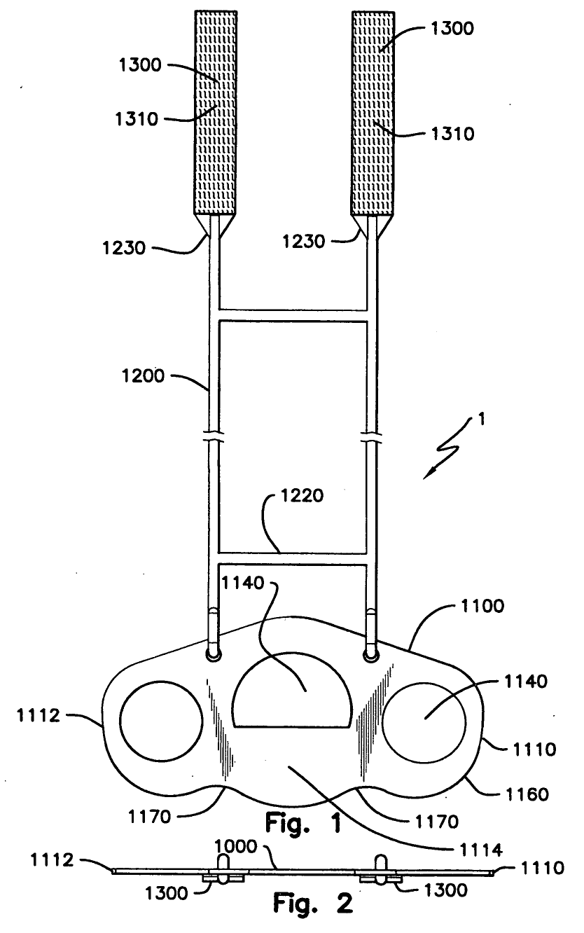

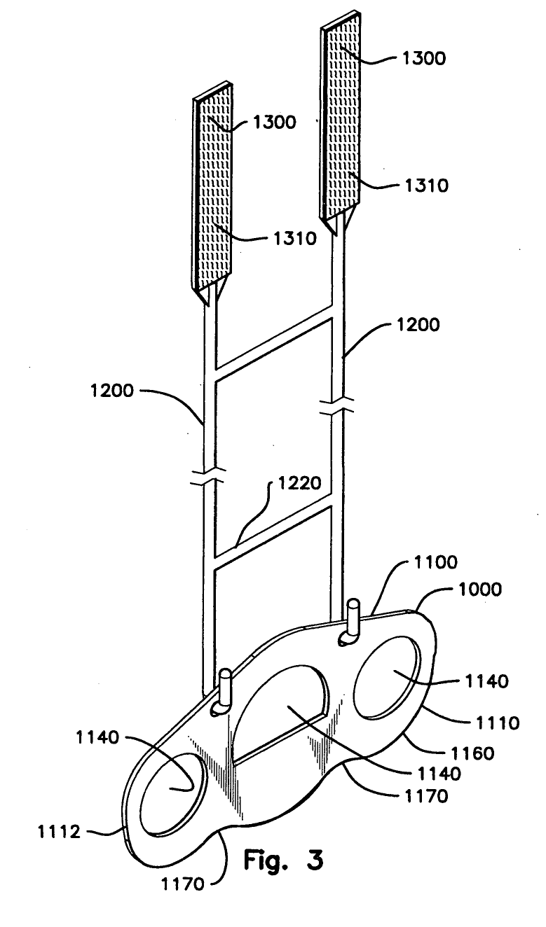

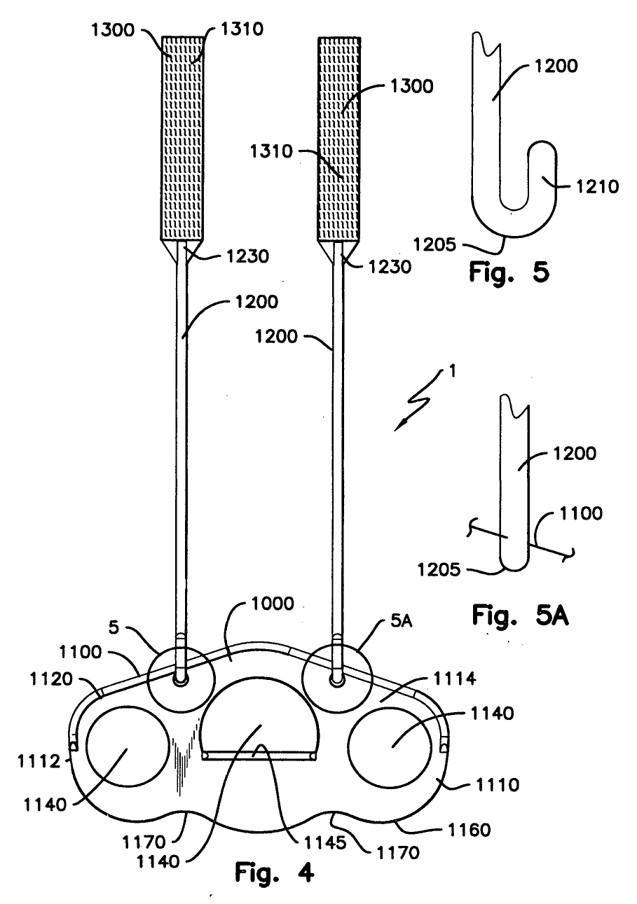

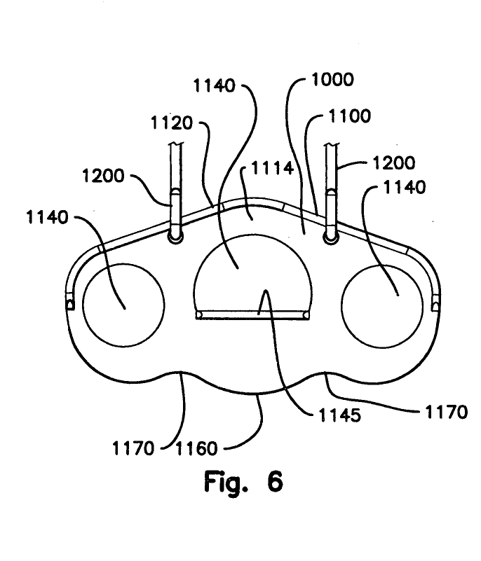

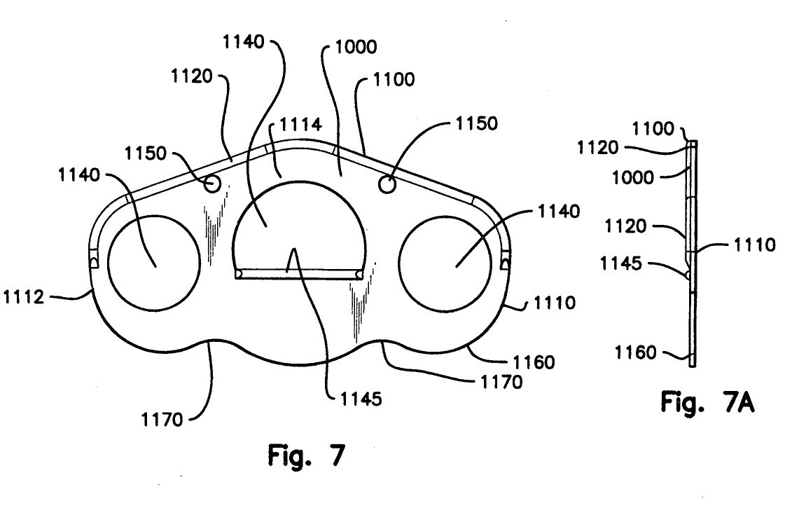

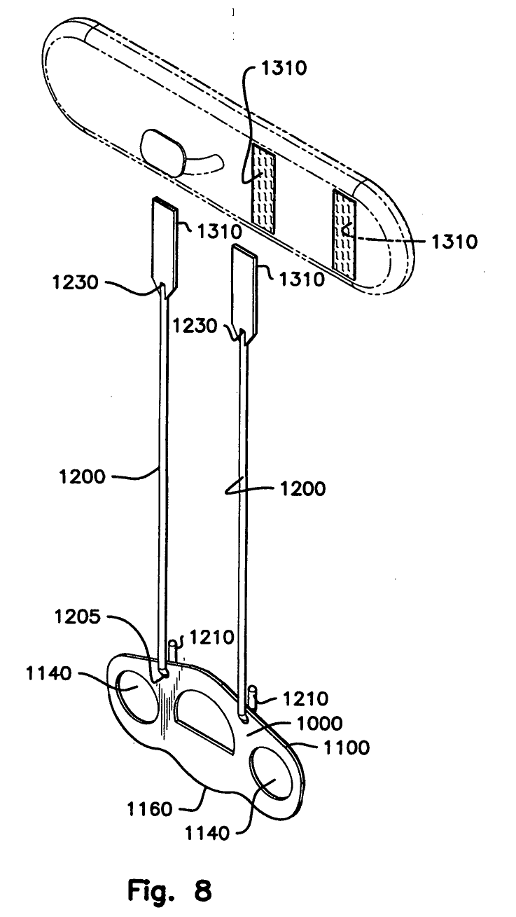

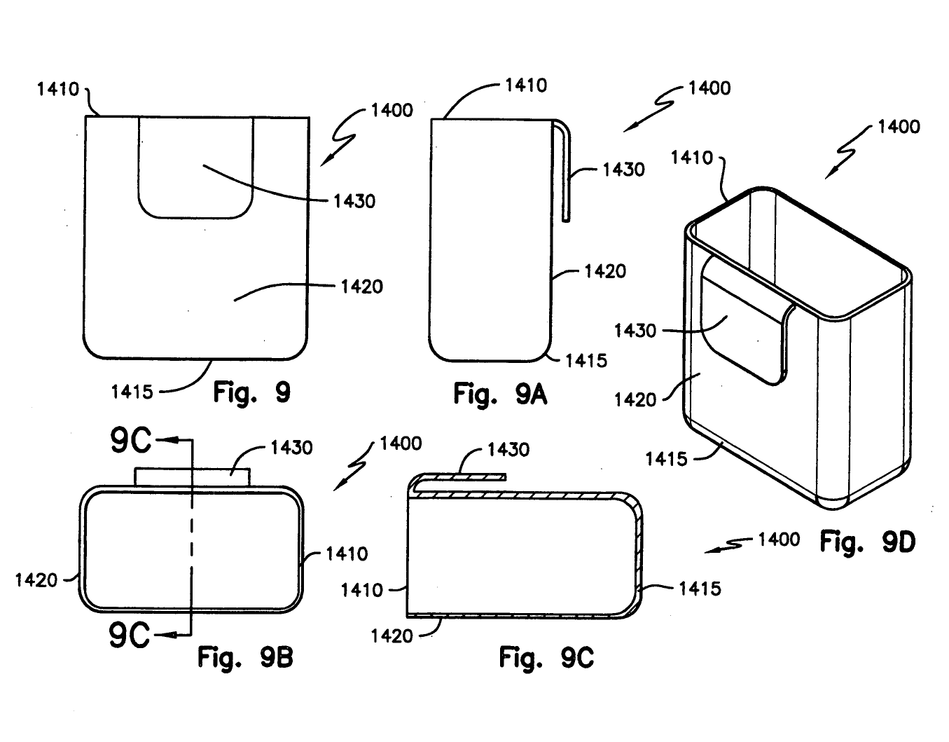

### DETAILED DESCRIPTION

The What is claimed is suspension storage device (1) comprising a substantially planar storage device (1000) having a leading edge (1100), a first side (1110), a second side (1112), a top surface (1114), at least one hanging aperture (1140) intermediate the first side (1110) and the second side (1112) and a trailing edge (1160) having at least one scallop (1170). The at least one hanging aperture comprising 1-n apertures. The at least one hanging aperture formed to receive a shaft, as in the earpieces for sunglasses, or a clip as in a clip for a blue tooth headset, or a shaft, as in a golf club. The at least one hanging aperture formed in the shape of a circle, a semi-circle, an ellipse, or a polygonal or irregular geometric shape.

At least two suspenders (1200) are affixed by suspender affixing means to the storage device (1000). Each of said at least two suspenders (1200) has a suspender storage device end (1205) and a suspender attachment end (1230). The suspender storage device end (1205) is affixed by suspender storage device end affixing means to the storage device (1000) at or proximal to the leading edge (1100). The suspender storage device end affixing means is generally rigid and will resist sway.

A substantially planar attachment tab (1300) is affixed by tab attachment means at each of the suspender attachment ends (1230). The attachment tab (1300) has an attachment tab surface (1305) and attachment tab surface (1305) surface affixing means is affixed by surface affixing means at the attachment tab surface (1305).

The storage device (1000) and suspenders (1200) and brace (1220) are formed from a rigid or semi-rigid material including plastics, metals and composite materials. Those of ordinary skill in the material arts will recognize that additional materials will be of sufficient rigidity to assist in the resistance of sway of the invention when utilized, for example, in a motor vehicle.

The leading edge (1100) of the storage device may be straight, curved or swept back. However, it will be recognized that the shape will bear on the flexibility of the invention and hence on the tendency to resist sway. In the preferred embodiment the shape of the leading edge (1100) is swept back.

The at least one hanging aperture (1140) is comprised of at least two hanging apertures (1140). The at least one scallop (1170) is concave. In the preferred embodiment one of the at least two hanging apertures (1140) is proximal the first side (1110) and one of the at least two hanging apertures (1140) is proximal the second side (1112).

One of the at least two suspenders (1200) (1205) is affixed by suspender storage device end affixing means to the storage device (1000) at or proximal to the leading edge (1100) proximal the first side (1110) and distal to the second side (1112). One of the at least two suspenders (1200) (1205) is affixed by suspender storage device end affixing means to the storage device (1000) at or proximal to the leading edge (1100) proximal the second side (1112) and distal to the first side (1110).

Surface affixing means, in the preferred embodiment, is comprised of attachment Velcro® (1310) affixed by Velcro® affixing means to each of the attachment tabs (1300) and engagable with mating Velcro® affixing means at a mounting surface, for example the back side of a vehicle rear view mirror.

The trailing edge (1160), in the preferred embodiment has at least two scallops (1170). For additional structural rigidity there may be a leading edge structural support (1120) proximal to or coincident with the leading edge (1100). For additional structural rigidity there may be a hanging aperture structural support (1145) integral with the at least one hanging aperture (1140). The hanging aperture structural support (1145), in the preferred embodiment, is substantially orthogonal to each of the at least two suspenders (1200). In the preferred embodiment there is at least one suspender brace (1220), forming a cross-brace, affixed by brace affixing means to each of the at least two suspenders (1200). The at least one suspender brace (1220), in the preferred embodiment, is substantially perpendicular to each of the at least two suspenders (1200).

In an embodiment where there is a leading edge structural support (1120), such will extend from or proximal to the first side (1110) to or proximal to the second side (1112). The at least one suspender brace (1220), in the preferred embodiment, is substantially perpendicular to each of the at least two suspenders (1200). The at least one hanging aperture (1140) may be formed of a variety of shapes depending on the use of the invention including, but not limited to, circular, semi-circular, elliptical or polygonal

The leading edge structural support (1120), in the preferred embodiment, extends outward from the top surface (1114) forming primarily a semi-circle in cross-section. The hanging aperture structural support (1145), in the preferred embodiment, extends outward from the top surface (1114) forming primarily a semi-circle in cross-section and being primarily perpendicular to the at least two suspenders (1200). It will be recognized that such structural support structures may be of a variety of shapes and cross-sections.

The interconnection of the at least two suspenders (1200) and the storage device (1000) may be accomplished in a variety of ways. One form of connection will be by forming at least two hook apertures (1150) in the storage device (1000) proximal the leading edge (1100) with one of the at least two hook apertures (1150) proximal the first side (1110) and the other of the at least two hook apertures proximal the second side (1112). The suspender storage device end affixing means in this option is comprised of a suspender hook (1210), at the suspender storage device end (1205), with the at least two hook apertures (1150) sized to receive a suspender hook (1210) friction secured and removable.

In the preferred embodiment the suspender storage device end affixing means is comprised by integral formation of the suspender storage device end (1205) with the storage device (1000) by plastic injection molding or metal or composite material machining or molding.

The hanging aperture structural support (1145) receives a container clip (1430) affixed to a container (1400). The container (1400) having a container top (1410), a container bottom (1415), at least one container wall (1420) and a container exterior (1425). The container clip (1430) is affixed to the container (1400) proximal or at the container top (1410) and is downwardly extending. The container clip (1430) and the at least one container wall (1420) at the container exterior (1425) exert pressure or friction against the storage device (1000) to retain the container (1400) in place. In the preferred embodiment the container (1400) is rectangular in cross-section but, may have any cross section including circular and others. In the preferred embodiment the container (1400) is formed from a plastic injection process from rigid materials and the container clip (1430) provides a spring function to secure the storage device (1000) between the container clip (1430) and the at least one container wall (1420).

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A suspension storage device (1) comprising:
a. a substantially planar storage device (1000) having at least one hanging aperture (1140);
b. at least one suspender (1200) affixed by suspender storage device end affixing means to the storage device (1000);
c. a substantially planar attachment tab (1300) affixed by tab attachment means to the at least one suspender (1200) distal from the storage device (1000).

2. The suspension storage device (1) of claim 1 further comprising:
a. the substantially planar storage device (1000) having a leading edge (1100), a first side (1110), a second side (1112), a top surface (1114), at least one hanging aperture (1140) intermediate the first side (1110) and the second side (1112) and a trailing edge (1160) having at least one scallop (1170);
b. at least two suspenders (1200); each of said at least two suspenders (1200) having a suspender storage device end (1205) and a suspender attachment end (1230); the suspender storage device end (1205) affixed by suspender storage device end affixing means to the storage device (1000) at or proximal to the leading edge (1100);
c. a substantially planar attachment tab (1300) affixed by tab attachment means at each of the suspender attachment ends (1230); the attachment tab (1300) having an attachment tab surface (1305); attachment tab surface (1305) surface affixing means affixed by surface affixing means at the attachment tab surface (1305).

3. The suspension storage device (1) of claim 2 further comprising:
a. the storage device (1000) formed from a rigid or semi-rigid material; the leading edge (1100) being straight, semi-circular or swept back in form; the at least one hanging aperture (1140) comprised of at least two hanging apertures (1140);

4. The suspension storage device (1) of claim 3 further comprising:
a. the rigid or semi-rigid material forming the storage device (1000) composed of plastics, metals and composite materials; the at least one scallop (1170) concave; one of the at least two hanging apertures (1140) proximal the first side (1110) and one of the at least two hanging apertures (1140) proximal the second side (1112);
b. one of the at least two suspenders (1200) (1205) affixed by suspender storage device end affixing means to the storage device (1000) at or proximal to the leading edge (1100) proximal the first side (1110) and distal to the second side (1112); one of the at least two suspenders (1200) (1205) affixed by suspender storage device end affixing means to the storage device (1000) at or proximal to the leading edge (1100) proximal the second side (1112) and distal to the first side (1110);
c. surface affixing means comprised of attachment Velcro (1310) affixed by Velcro affixing means to each of the attachment tabs (1300) and engagable with mating Velcro affixing means at a mounting surface, for example the back side of a vehicle rear view mirror.

5. The suspension storage device (1) of claim 4 further comprising:
a. the trailing edge (1160) having at least two scallops (1170); a leading edge structural support (1120) proximal to or coincident with the leading edge (1100); at least one hanging aperture (1140) having a hanging aperture structural support (1145); at least one suspender brace (1220) affixed by brace affixing means to each of the at least two suspenders (1200);
b. the leading edge (1100) is swept back in form.

6. The suspension storage device (1) of claim 5 further comprising:
a. the leading edge structural support (1120) extending from or proximal to the first side (1110) to or proximal to the second side (1112); the at least one suspender brace (1220) being substantially perpendicular to each of the at least two suspenders (1200);
b. the at least one hanging aperture (1140) being circular, semi-circular, elliptical or polygonal in cross section; the hanging aperture structural support (1145) being circular, semi-circular, elliptical or polygonal in cross section;

7. The suspension storage device (1) of claim 6 further comprising:
a. the leading edge structural support (1120) extending outward from the top surface (1114) forming primarily a semi-circle in cross-section; the hanging aperture structural support (1145) extending outward from the top surface (1114) forming primarily a semi-circle or a polygonal in cross-section; the hanging aperture structural support (1145) is substantially orthogonal to each of the at least two suspenders (1200).

8. The suspension storage device (1) of claim 7 further comprising:
a. at least two hook apertures (1150) proximal the leading edge (1100) with one of the at least two hook apertures (1150) proximal the first side (1110) and the other of the at least two hook apertures proximal the second side (1112); the the suspender storage device end affixing means comprised of a suspender hook (1210) at the suspender storage device end (1205); the at least two hook apertures (1150) sized to receive a suspender hook (1210) friction secured and removable.

9. The suspension storage device (1) of claim 7 further comprising:
a. the suspender storage device end affixing means comprised by integral formation of the suspender storage device end (1205) with the storage device (1000) by plastic injection molding or metal or composite material machining or molding.

10. The suspension storage device (1) of claim 8 further comprising:
a. the hanging aperture structural support (1145) receives a container clip (1430) affixed to a container (1400) having a container top (1410), a container bottom (1415), at least one container wall (1420) and a container exterior (1425); the container clip affixed to the container (1400) proximal or at the container top (1410) and is downwardly extending; the container clip (1430) and the at least one container wall (1420) at the container exterior (1425) exerting pressure or friction against the storage device (1000) to retain the container (1400) in place.

11. The suspension storage device (1) of claim 9 further comprising:
a. the hanging aperture structural support (1145) receives a container clip (1430) affixed to a container (1400) having a container top (1410), a container bottom (1415), at least one container wall (1420) and a container exterior (1425); the container clip affixed to the container (1400) proximal or at the container top (1410) and is downwardly extending; the container clip (1430) and the at least one container wall (1420) at the container exterior (1425) exerting pressure or friction against the storage device (1000) to retain the container (1400) in place.
